(19) United States
(12) Patent Application Publication
(10) Pub. No.: US 2012/0117580 A1
(43) Pub. Date: May 10, 2012

(54) OPTICAL PICKUP AND OPTICAL DISC DRIVE INCLUDING THE OPTICAL PICKUP

(76) Inventors: Jun-ichi Asada, Hyogo (JP); Hiroaki Matsumiya, Osaka (JP); Kazuo Momoo, Osaka (JP)

(21) Appl. No.: 13/100,327

(22) Filed: May 4, 2011

(30) Foreign Application Priority Data
Nov. 9, 2010 (JP) 2010-250521

(51) Int. Cl. G11B 7/135; G11B 19/20

(52) U.S. Cl. 720/695; 369/112.03; G9B/7.113; G9B/19.027

(57) ABSTRACT

According to the present invention, a tracking error signal can be obtained with good stability by the three-beam differential push-pull method even if the track guide groove direction of the optical disc changes as viewed from the objective lens.

An optical pickup 30 according to the present invention includes: a grating element 110 for splitting light emitted from a light source 121 into multiple light beams including zero-order, −first-order and +first-order diffracted light beams; an objective lens 118 for condensing the zero-order and ±first-order diffracted light beams, which have come from the grating element 110, onto an optical disc; and a photosensor 101 with multiple photodetectors for receiving respectively the three diffracted light beams reflected from the optical disc. The grating element 110 is designed so that when measured perpendicularly to tracks on the disc, sub-light beam spots formed on the disc by the ±first-order diffracted light beams are larger than a main light beam spot formed on the disc by the zero-order diffracted light beam.

### BACKGROUND OF THE INVENTION

1. Field of the Invention

The present invention relates to an optical pickup for optically accessing an optical disc and also relates to an optical disc drive including such an optical pickup.

2. Description of the Related Art

In writing information on an optical disc or any other type of optical storage medium, servo technologies are indispensable to form a light beam spot at a target location on the medium which the information is going to be written on and will then be read from. There are various kinds of servo signals, but a focus error signal and a tracking error signal are used particularly frequently among those signals. From the light that has been reflected from an information storage medium such as an optical disc, errors should be detected accurately via these error signals and the information thus obtained as those error signals should be fed back and used to control the position of the objective lens precisely. Among these kinds of servo controls, a tracking control is performed to make a light beam spot follow a target track on an information storage layer (which will be simply referred to herein as a “storage layer”) of an optical disc such as a CD or a DVD, and a differential push-pull method (which will be referred to herein as a “DPP method”) is used extensively to get the tracking control done. According to a conventional DPP method, the light that has been emitted from a light source is split by a diffraction grating element (which will be simply referred to herein as a “grating element”) into three light beams, namely, a zero-order diffracted beam and ± first-order diffracted beams. And by condensing these three light beams, three light beam spots are formed on the storage layer of the optical disc, thereby obtaining a tracking error signal.

A conventional method for detecting a DPP signal using a grating element is disclosed in Japanese Patent Gazette for Opposition No. 04-34212 (which will be referred to herein as “Patent Document No. 1” for convenience sake).

Hereinafter, the principle of the DPP method will be briefly described with reference to FIGS. 1 through 5.

FIG. 1 is a perspective view illustrating a situation where three light beam spots have been formed on an optical disc. In FIG. 1, a portion of the optical disc is schematically illustrated on a larger scale. On the optical disc, arranged either concentrically or spirally are tracks that have been formed as either grooves 20 or lands 22. A grating element with a uniform periodic structure splits the incoming light beam that has come from a light source into a zero-order beam (as main beam), a +first-order beam (as sub-beam A) and a −first-order beam (as sub-beam B). These three light beams are condensed toward the optical disc surface, thereby forming a main light beam spot 12 and sub-light beam spots 14 and 16 there. In the example illustrated in FIG. 1, the main light beam spot 12 is located on the central track (and on the groove 20), while the sub-light beam spots 14 and are located on the lands 22 that interpose the central track (the groove 20) between them.

Next, a basic configuration for a conventional grating element 112 will be described with reference to FIGS. 2 and 3. FIGS. 2(a) and 2(b) respectively illustrate schematically a side view and a front view of the grating element 112. This grating element has a periodic structure, of which the thickness changes periodically in the Y-axis direction shown in FIG. 2. In the X-axis direction, on the other hand, this periodic structure is uniform. Although the periodic structure of this example is implemented by such a variation in thickness, the same periodic structure may also be obtained even by changing the refractive index in the Y-axis direction. The circle drawn on the grating element 112 shown in FIG. 2(b) indicates a cross section of a light beam that has been incident on this grating element 112.

FIG. 3 is a cross-sectional view illustrating how the incoming light beam that has been incident on this grating element 112 is split into a zero-order beam (main beam), a +first-order beam (first sub-beam) and a −first-order beam (second sub-beam). In this case, the branching angles (or diffraction angles) of the incoming light beam are determined by the wavelength of the light beam and the pitch of the periodic structure of the grating element.

Now, take a look at FIG. 1 again. When the tracking control is ON, the main light beam spot 12 traces accurately the groove 20 on which signal pits have been left. The grating element 112 has been arranged and fixed so that the two sub-light beam spots 14 and 16 are radially shifted by a half of the track groove pitch [symbol] (= [symbol] /2) from the main light beam spot 12 and are located right on the lands 22. As shown in FIG. 1, these three light beam spots 12, 14 and 16 are arranged in line, which is slightly tilted with respect to the direction in which the tracks run. If the grating element 112 is rotated on an axis that is defined perpendicularly to the principal surface of the grating element 112, the direction of that line on which the three light beam spots 12, 14 and 16 are arranged changes. If when the main light beam spot 12 is located on the central track, the sub-light beam spots 14 and 16 should be accurately shifted by [symbol] /2 from the central track as shown in FIG. 1, the angle of rotation of the grating element 112 needs to be adjusted accurately.

FIG. 4 illustrates an exemplary configuration for a photosensor that receives the light that has been reflected from an optical disc. An optical pickup for an optical disc drive that performs a tracking control by the DPP method has a group of photodetectors 32, 34 and 36 on which the main light beam spot 12 and the two sub-light beam spots 14 and 16 will be formed. Each of these three photodetectors 32, 34 and 36 has been split into two photodiodes. And by calculating the difference between those two divided photodiodes of each photodetector, three tracking error signals (which will be respectively referred to herein as “main TE” and “sub-A TE” and “sub-B TE” that are two sub-TE signals) are generated.

By making the calculation represented by the following Equation (1) on the output signals of these three photodetectors 32, 34 and 36, a tracking error signal, from which a DC signal offset due to a lens shift or any other factor has been cancelled (and which will be referred to herein as a “DPP signal”), can be obtained:

DPP=main TE−k(TE(sub-A)+TE(sub-B)) (1)

where k is a constant.

FIG. 5 shows three waveforms representing how the signal outputs of the main TE, sub-TE and DPP change as the light beam spots deviate from their target tracks. In this case, the sub-TE is a signal representing the sum of the sub-A TE that has been generated by the photodetector 34 and the sub-B TE that has been generated by the photodetector 36.

As shown in FIG. 5, since the interval between their associated light beam spots is a half of the groove pitch, the main TE and sub-TE have two phases that are shifted from each other by 180 degrees and also have two opposite polarities. That is to say, when the main light beam spot 12 is located on a groove 20, the sub-light beam spots 14 and 16 are located on its adjacent lands 22. Conversely, when the main light beam spot 12 is located on a land 22, the sub-light beam spots 14 and 16 are located on its adjacent grooves 20. That is why the polarity of one of these two tracking error signals that represents the movement of one light beam spot across the grooves on the disc is opposite to that of the other tracking error signal that represents the movement of the other light beam spot across those grooves. On the other hand, if the relative position of the objective lens has changed due to the eccentricity of the disc, for example (i.e., if a lens shift has occurred), then DC signal offsets of the same polarity will arise in both of the main TE and sub-TE. In that case, the magnitudes of these offsets A and B of the main TE and the sub-TE could be different from each other.

For that reason, if the k value has been determined appropriately when k times the sub-TE is subtracted from the main TE by Equation (1), an offset-free tracking error signal can be obtained as a DPP signal.

Recently, more and more optical disc drive products are compatible with multiple different types of optical storage media such as optical discs (including CDs, DVDs and BDs) that have mutually different storage densities, storage capacities and disc substrate thicknesses and that are compliant with respectively different standards.

As the wavelength of the light source, the storage density and the disc substrate thickness need to be changed according to the type of the optical disc loaded (which may be a BD, a DVD or a CD, for example), it is difficult for a single objective lens to form an ideal light beam spot on the target storage layer of each of these optical discs. That is why an optical pickup that is compatible with all of these types of storage media compliant with multiple different standards has at least two objective lenses.

FIG. 6 illustrates an exemplary arrangement of an optical system for an optical pickup that uses two objective lenses.

The incoming light that has come from a light source 111, which can emit light beams with two different wavelengths for use to perform a read/write operation on DVDs and on CDs, is diffracted and split by a grating element 112 into a zero-order beam and ±first-order beams, which are transmitted through optical members and then reflected by a reflective mirror 106. Thereafter, the zero-order and ±first-order light beams are condensed by an objective lens 107, which can be used in common for both DVDs and CDs (and which will be referred to herein as a “DVD/CD-compatible objective lens”), onto a disc 108. On its way back, the light beam is reflected from the disc 108, transmitted through a beam splitter 103, and then incident on a photosensor 101, where the photodetectors 32, 34 and 36 shown in FIG. 4 generate the main TE and sub-TE signals. Specifically, the main TE signal is generated by the photodetector 32 of the photosensor 101 and the sub-TE signals are generated by the photodetectors 34 and 36 of the photosensor 101. And by making the calculation represented by Equation (1), a DC-offset-free TE signal is generated as a DPP signal.

On the other hand, a light beam with the wavelength for reading and writing from/to BDs is emitted from another light source 121, transmitted through the reflective mirror 106 for DVDs and CDs, and then reflected from a reflective mirror 116 for BDs. After that, the light beam is condensed by a BD-dedicated objective lens 117 onto a disc 118. On its way back, the light beam is reflected from the disc 118, transmitted through the beam splitter 103, and then split into multiple light beams by a hologram 120. And those split light beams are eventually incident on the photosensor 101, which generates a required signal.

In this manner, a part of the optical system can be used in common for both BDs and CDs/DVDs on the way toward the disc (i.e., from the beam splitter 103 through the objective lens) and on the way back from the disc (i.e., from the objective lens through the photosensor). As a result, this optical pickup that is compatible with multiple different types of optical discs using light beams with respectively different wavelengths can have an optical system of a reduced overall size.

FIG. 7 is a top view illustrating a position of an optical pickup with respect to an optical disc. In FIG. 7, the optical pickup is moved along the X-axis that passes the center ◯ of the disc.

In this case, the DVD/CD-compatible objective lens 107 has its center located on the X-axis. If this optical pickup is moved either outward from some inner location (closer to the disc center) toward the outer edge of the disc or inward from some outer location toward the inner edge or the center of the disc, then the objective lens 107 moves along the X-axis. That is why as viewed from the DVD/CD-compatible objective lens 107, the disc groove direction (i.e., a tangential direction that is defined with respect to the concentric circles drawn around the center ◯) is always the Y-axis direction, no matter whether the optical pickup is located closer to the inner edge of the disc or to its outer edge. Consequently, the relative positions of the main- and sub-light beam spots that are formed by a fixed grating element do not change irrespective of the disc radial location of the optical pickup. For that reason, even when such an optical pickup with two objective lenses is used, the conventional DPP method is applicable as it is to the DVD/CD-compatible optical system.

On the other hand, the BD-dedicated objective lens 117 is not located on the X-axis as shown in FIG. 7. That is why if the optical pickup is moved parallel to the X-axis, the disc groove direction (i.e., a tangential direction that is defined at each location with respect to the concentric circles) as viewed from the BD-dedicated objective lens 117 changes continuously according to the disc radial location. For that reason, if the conventional DPP method were applied as it is to BDs, a phase shift would occur between the main- and sub-TE signals and the amplitude of the DPP signal would vary significantly. Consequently, the conventional three-beam method cannot be used to detect TE with such an objective lens that has offset from the X-axis (i.e., the BD-dedicated objective lens 117 in this example) and a three-beam detector cannot be used in common for both BDs and DVDs/CDs, which is a problem that remains unsolved.

It is therefore an object of the present invention to provide an optical pickup that can generate a TE-offset-free TE signal with good stability even if two objective lenses thereof are arranged at two different positions in the tracking direction.

### SUMMARY OF THE INVENTION

An optical pickup according to the present invention includes: a light source for emitting light; a grating element for splitting the light emitted from the light source into multiple light beams including a zero-order diffracted light beam, a −first-order diffracted light beam, and a +first-order diffracted light beam; an objective lens for condensing the zero-order diffracted light beam and the ±first-order diffracted light beams, which have come from the grating element, onto an optical disc; and a photosensor that has multiple photodetectors for receiving respectively the three diffracted light beams that have been reflected from the optical disc. The grating element is designed so that when measured perpendicularly to tracks on the optical disc, sub-light beam spots that are formed on the optical disc by the ±first-order diffracted light beams are larger than a main light beam spot that is formed on the optical disc by the zero-order diffracted light beam.

In one preferred embodiment, each of the sub-light beam spots is wide enough to cover, or at least overlap with, both lands and grooves of the disc.

In another preferred embodiment, the grating element is comprised of a number of divided regions that are arranged in a first direction. Each of the divided regions has a periodic structure for diffracting incoming light. The period of the periodic structure is constant no matter where the divided region is located in the first direction. But the phase of the periodic structure changes stepwise according to the location of the divided region in the first direction.

In this particular preferred embodiment, those divided regions are arranged in stripes so as to run in a second direction that is defined perpendicularly to the first direction.

In a specific preferred embodiment, the phase of the periodic structure does not change within each said striped divided region.

In a more specific preferred embodiment, the periodic structures of the divided regions are symmetric with respect to a line that passes the center of the grating element and that is defined parallel to the second direction.

In another specific preferred embodiment, the periodic structure of each of the divided regions forms respective parts of concentric curves within that divided region.

In another preferred embodiment, the divided regions have non-uniform widths.

In still another preferred embodiment, each of the divided regions has first and second groups of regions that are arranged alternately in the second direction. The first group of regions that are included in the multiple divided regions are arranged in the first direction and the phases of their periodic structures change stepwise in the first direction. The second group of regions that are included in the multiple divided regions are also arranged in the first direction and the phases of their periodic structures change stepwise in the first direction. And the phase shift of the periodic structures of the first group of regions has an opposite polarity to that of the periodic structures of the second group of regions.

In this particular preferred embodiment, the divided regions have non-uniform widths.

In yet another preferred embodiment, the optical pickup further includes: a second light source for emitting light; a second grating element for splitting the light emitted from the second light source into multiple light beams including a zero-order diffracted light beam, a −first-order diffracted light beam, and a +first-order diffracted light beam; a second objective lens for condensing the zero-order diffracted light beam and the ±first-order diffracted light beams, which have come from the second grating element, onto an optical disc; and a second photosensor that has multiple photodetectors for receiving respectively the three diffracted light beams that have been reflected from the optical disc.

An optical disc drive according to the present invention includes: an optical pickup; a motor for rotating an optical disc; and a control section for performing a tracking control in response to a tracking error signal that has been generated by the optical pickup. The optical pickup includes: a light source for emitting light; a grating element for splitting the light emitted from the light source into multiple light beams including a zero-order diffracted light beam, a −first-order diffracted light beam, and a +first-order diffracted light beam; an objective lens for condensing the zero-order diffracted light beam and the ±first-order diffracted light beams, which have come from the grating element, onto an optical disc; and a photosensor that has multiple photodetectors for receiving respectively the three diffracted light beams that have been reflected from the optical disc. The grating element is designed so that when measured perpendicularly to tracks on the optical disc, sub-light beam spots that are formed on the optical disc by the ±first-order diffracted light beams are larger than a main light beam spot that is formed on the optical disc by the zero-order diffracted light beam.

In one preferred embodiment, the control section cancels the DC components of a main tracking error signal that has been generated based on the main light beam spot with those of sub-tracking error signals that have been generated based on the sub-light beam spots.

In another preferred embodiment, if a line is defined so as to pass the center of the optical disc and to be parallel to the direction in which the optical pickup is moved, the position of the objective lens is shifted perpendicularly to that line.

In still another preferred embodiment, the optical pickup further includes another objective lens that is located on a line that passes the center of the optical disc and is parallel to the direction in which the optical pickup is moved.

Even if the disc groove direction as viewed from the objective lens changes continuously as the optical pickup is moved, the optical pickup of the present invention can still generate a tracking error signal with good stability with the offset cancelled by the three-beam method. As a result, the photodetector of this optical pickup can have a simplified configuration. In addition, as there is no need to make rotation adjustment on the grating element, the manufacturing process of the optical pickup can be simplified. Furthermore, the variation in characteristic with the positional shift of the rotating grating element with time can also be reduced significantly.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view illustrating where light beam spots formed by a conventional three-beam DPP method are located on an optical disc.

FIGS. 2(a) and 2(b) respectively illustrate schematically a side view and a front view of a grating element 112.

FIG. 3 is a cross-sectional view illustrating how the incoming light beam that has been incident on the grating element is split into a zero-order beam (main beam), a +first-order beam (first sub-beam) and a −first-order beam (second sub-beam).

FIG. 4 illustrates an exemplary configuration for a photosensor that receives the light that has been reflected from an optical disc.

FIG. 5 shows how the signal outputs of the main TE, sub-TE and DPP change as the light beam spots deviate from their target tracks.

FIG. 6 illustrates an exemplary arrangement of an optical system for an optical pickup that uses two objective lenses.

FIG. 7 is a top view illustrating the relative arrangement of an optical pickup with respect to an optical disc.

FIG. 8A is a block diagram illustrating an exemplary configuration for an optical disc drive as a preferred embodiment of the present invention.

FIG. 8B illustrates an arrangement for an optical pickup according to a first preferred embodiment of the present invention.

FIG. 8C is a cross-sectional view illustrating how a grating element diffracts and splits the incoming light into a zero-order light beam (“main beam”) and ±first-order light beams (“first and second sub-beams”).

FIG. 8D is a top view illustrating the relative position of the optical pickup with respect to the optical disc in the first preferred embodiment of the present invention.

FIG. 9 illustrates an arrangement of photodetectors according to the first preferred embodiment of the present invention.

FIG. 10 is a plan view illustrating a grating element according to the first preferred embodiment of the present invention.

FIG. 11 illustrates the configuration of the grating element according to the first preferred embodiment of the present invention.

FIG. 12 illustrates light beam spots formed on a disc according to the first preferred embodiment of the present invention.

FIG. 13A shows the waveforms of groove-crossing signals TE1(14) and TE2(14) that form a tracking error signal according to the first preferred embodiment of the present invention.

FIG. 13B shows the waveforms of groove-crossing signals TE1(16) and TE2(16) that form another tracking error signal according to the first preferred embodiment of the present invention.

FIG. 13C shows the waveforms of tracking error signals according to the first preferred embodiment of the present invention.

FIG. 14 is a plan view illustrating a grating element according to a second preferred embodiment of the present invention.

FIG. 15 illustrates light beam spots formed on a disc according to the second preferred embodiment of the present invention.

FIG. 16A shows the waveforms of groove-crossing signals TE1(14) and TE2(14) that form a tracking error signal according to the second preferred embodiment of the present invention.

FIG. 16B shows the waveforms of groove-crossing signals TE1(16) and TE2(16) that form another tracking error signal according to the second preferred embodiment of the present invention.

FIG. 16C shows the waveforms of tracking error signals according to the second preferred embodiment of the present invention.

FIG. 17A is a plan view illustrating a grating element according to a third preferred embodiment of the present invention.

FIG. 17B is a plan view illustrating regions A and B in the first and second groups of the grating element according to the third preferred embodiment of the present invention.

FIG. 18 illustrates light beam spots formed on a disc according to the third preferred embodiment of the present invention.

FIG. 19A shows the waveforms of groove-crossing signals TE1(14) and TE2(14) that form a tracking error signal according to the third preferred embodiment of the present invention.

FIG. 19B shows the waveforms of groove-crossing signals TE1(16) and TE2(16) that form another tracking error signal according to the third preferred embodiment of the present invention.

FIG. 19C shows the waveforms of tracking error signals according to the third preferred embodiment of the present invention.

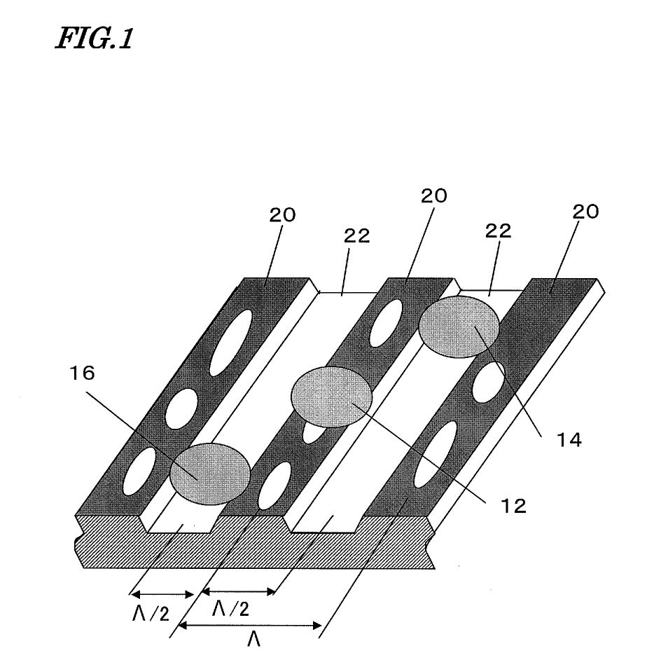

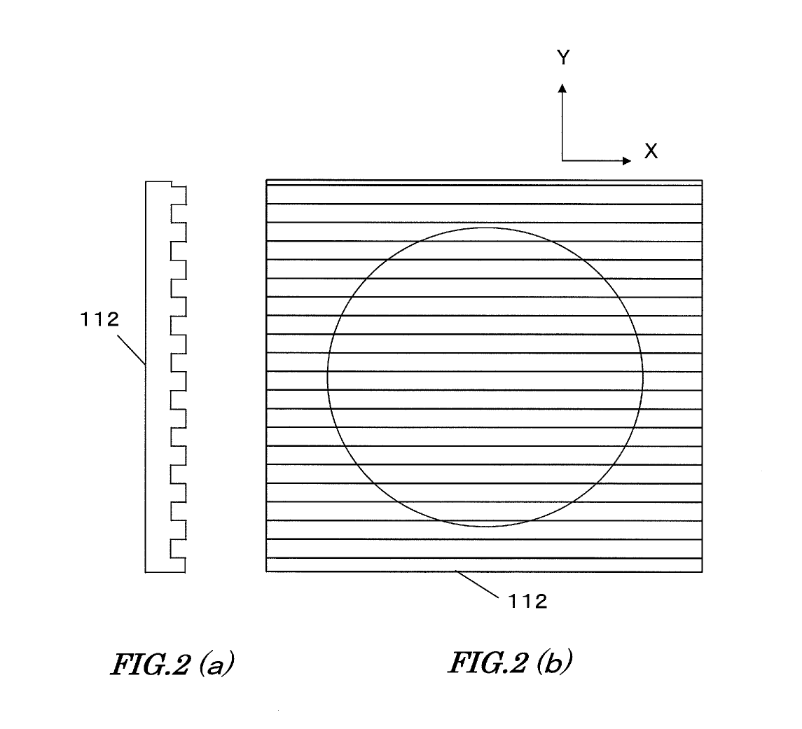

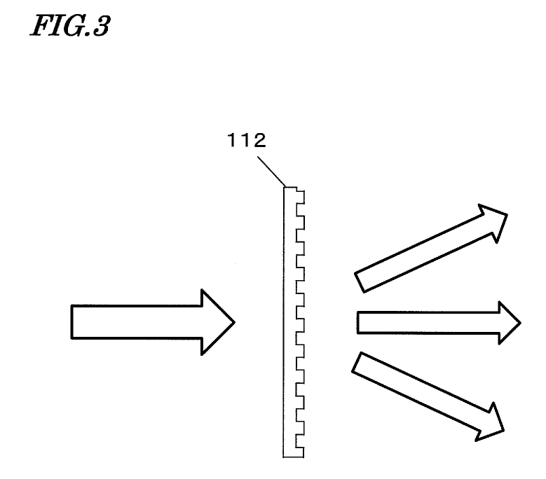

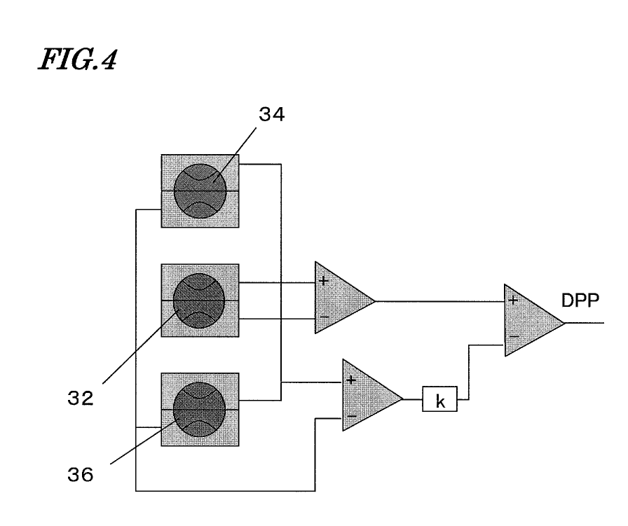

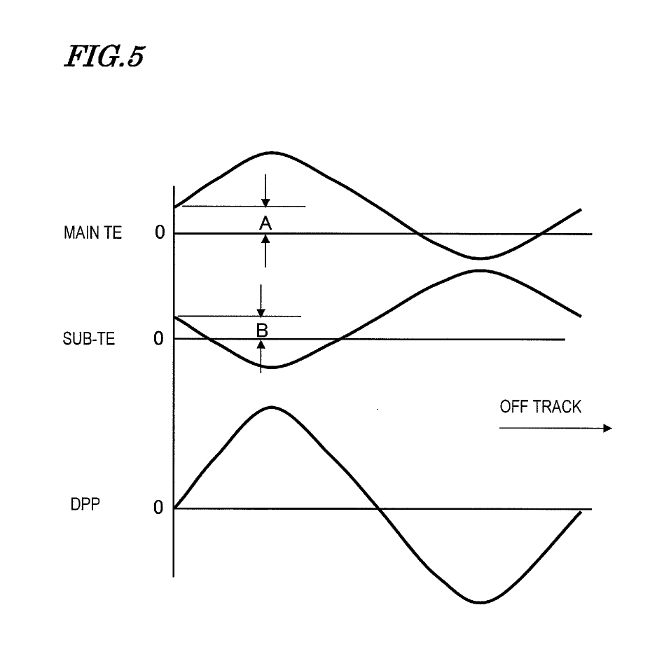

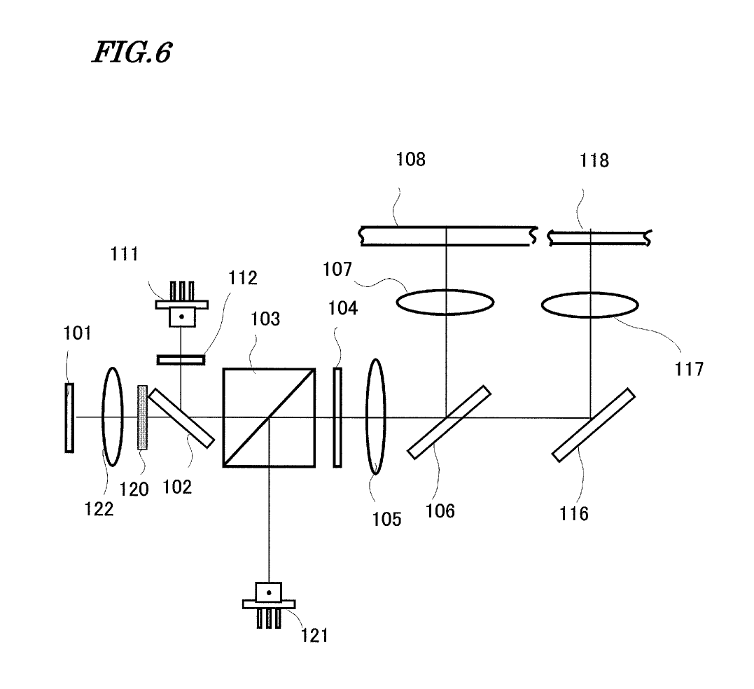

### DETAILED DESCRIPTION OF PREFERRED EMBODIMENTS

The optical pickup of the present invention detects the DC components of sub-TE signals that have been generated by sub-beams instead of the AC components thereof, thereby canceling the DC components of a main TE signal that has been generated by a main beam. Also, according to the present invention, the light beam spot shape and size of the sub-beams are specially designed so that the sub-TE signals have substantially no AC components. For example, the sub-beams may be produced so that when measured perpendicularly to the tracks on the optical disc, the size of the light beam spot of each sub-beam on the optical disc is approximately equal to, or even larger than, a track pitch. Such sub-beams may be produced by modifying a grating element that diffracts and splits the incoming light beam into three light beams. More specifically, by adjusting the phase wavefront of the sub-beams that have been produced by diffraction into a non-planar shape, the condensing state can be controlled and the light beam spot shape can be changed.

Hereinafter, preferred embodiments of an optical pickup according to the present invention and an optical disc drive including such an optical pickup will be described.

### Embodiment 1

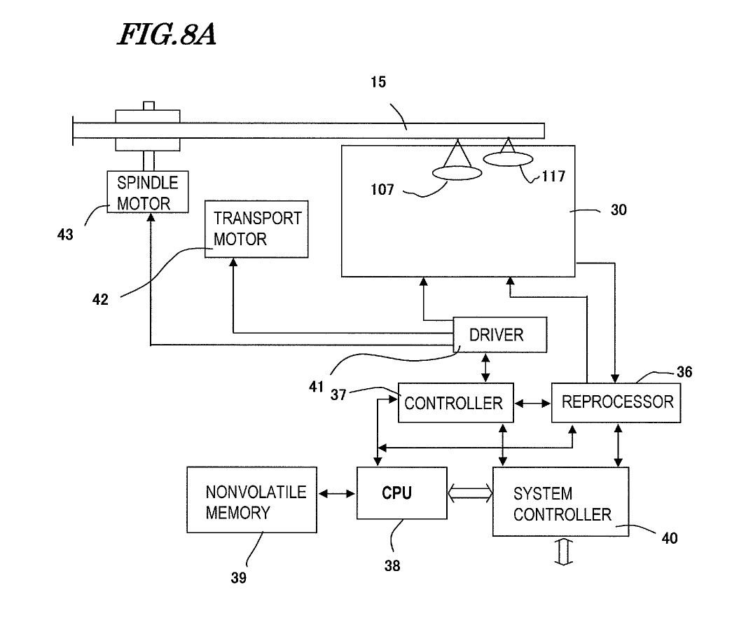

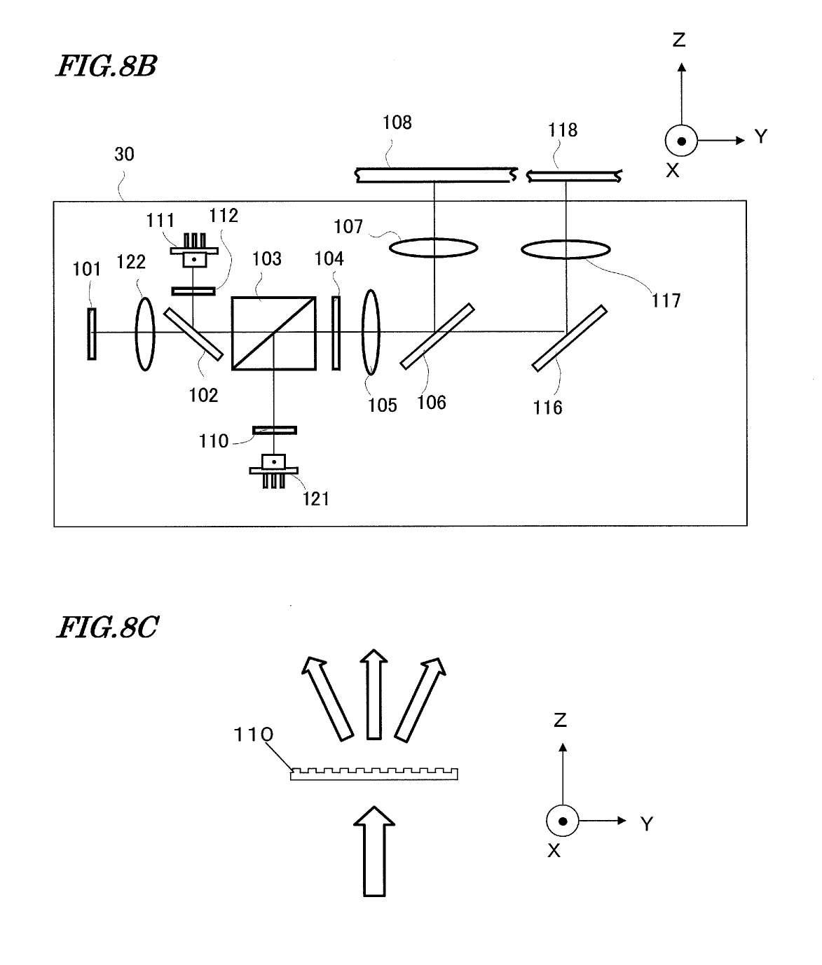

First of all, a Preferred Embodiment of an Optical disc drive according to the present invention will be described with reference to FIG. 8A.

The optical disc drive of this preferred embodiment includes an optical pickup 30, a spindle motor 43 for rotating an optical disc 15, a transport motor 42 for controlling the position of the optical pickup 30, and a control means for controlling the operations of all of these members. The optical pickup 30 is connected to a front-end processor 36 for performing signal processing and to a driver 41 for controlling the operation of the optical pickup 30 and exchanges electrical signals with them. The configuration of the optical pickup 30 will be described in detail later. Except the optical pickup 30, an optical disc drive as any other preferred embodiment of the present invention to be described later has the same configuration as the optical disc drive of this preferred embodiment. That is why when the second and third preferred embodiments of the present invention are described, description of the overall configuration of the optical disc drive will be omitted to avoid redundancies.

Data that has been read optically from the optical disc 15 is transformed by the photosensor of the optical pickup 30 into an electrical signal, which is supplied to the front-end processor 36 by way of a signal connector (not shown). The front-end processor 36 generates servo signals, including a focus error signal and a tracking error signal, based on the electrical signal that has been supplied from the optical pickup 30 and performs waveform equalization, binarization slicing and analog signal processing such synchronous data generation on the read signal.

The servo signals that have been generated by the front-end processor 36 are supplied to the controller 37, which controls the driver 41 so that the light beam spot formed by the optical pickup 30 keeps up with the optical disc 15 rotating. The driver 41 is connected to the optical pickup 30, the transport motor 42 and the spindle motor 43. The driver 41 gets a series of control operations, including the focus control and tracking control using condenser lenses 107 and 117, a transport control, and a spindle motor control, done as digital servo operations. That is to say, the driver works so as to drive an actuator (not shown) for the condenser lenses 107 and 111, the transport motor 42 for moving the optical pickup 30 either inward or outward with respect to the optical disc 15, and the spindle motor 43 for rotating the optical disc 15 appropriately.

The synchronous data that has been generated by the front-end processor 36 is subjected to digital signal processing by a system controller 40, and read/write data is transferred to a host by way of an interface circuit (not shown). The front-end processor 36, the controller 37 and the system controller 40 are connected to a central processing unit (CPU) 38 and operate under the instruction given by the CPU 38. A program that defines a series of operations, including control operations for rotating the optical disc 15, moving the optical pickup 30 to a target location, forming a light beam spot on a target track on the optical disc 15, and making the light beam spot follow the target track, is stored in advance as firmware in a semiconductor storage device such as a nonvolatile memory 39. Such firmware is retrieved from the nonvolatile memory 39 by the CPU 38 according to the mode of operation required.

The front-end processor 36, the controller 37, the CPU 38, the nonvolatile memory 39 and the system controller 40 will be collectively referred to herein as a “control means”.

Next, an arrangement for the optical pickup 30 of this preferred embodiment will be described with reference to FIG. 8B.

This optical pickup 30 includes: a semiconductor laser diode 121 for emitting a light beam to irradiate BDs; a semiconductor laser diode 111 for emitting two light beams with two different wavelengths that are associated with DVDs and CDs, respectively; a grating element 110 for diffracting and splitting the light emitted from the semiconductor laser diode 121 into a zero-order light beam (which will be referred to herein as a “main beam”) and ±first-order light beams (which will be referred to herein as “sub-beams”); another grating element 112 for diffracting and splitting the light emitted from the semiconductor laser diode 111 into a zero-order light beam (which will be referred to herein as a “main beam”) and ±first-order light beams (which will be referred to herein as “sub-beams”); a focusing optical system that receives and converges these light beams onto the target track on either a BD 118 or a DVD/CD 108, thereby forming a condensed light beam spot there; a wave plate 104 for changing the polarization state of the optical system depending on whether the light beam is going toward, or coming back from, the optical disc 108, 118; a beam splitter 103 for changing the optical path of the optical system depending on whether the light beam is going toward, or coming back from, the optical disc 108, 118; and a photosensor 101 for receiving the light beam that has been reflected from either the DVD/CD 108 or the BD 118. The focusing optical system includes a collimator lens 105, a BD-dedicated objective lens 117 and a DVD/CD-compatible objective lens 107.

FIG. 8C illustrates how the grating element 110 diffracts and splits the incoming light into a zero-order light beam (which will be referred to herein as a “main beam”) and ±first-order light beams (which will be referred to herein as “sub-beams”). These light beams that have been split in this manner will form three light beam spots on the optical disc.

This optical pickup 30 further includes a lens driving mechanism (not shown) for driving and moving the objective lens 107, 117 along the optical axis of the objective lens 107, 117 (i.e., in the Z-axis direction) and in the radial direction of the optical disc 10 (i.e., in the X-axis direction that comes out of the paper in FIG. 8B).

FIG. 8D schematically illustrates the relative position of the optical pickup with respect to tracks on the optical disc. The optical pickup 30 of this preferred embodiment has a two-lens structure with the BD-dedicated objective lens 117 and the DVD/CD-compatible objective lens 107.

In the following description, unless stated otherwise, the Z-axis direction is supposed to be the optical axis direction of the focusing optical system, the X-axis direction is supposed to be the radial direction on the optical disc 15, and the Y-axis direction is supposed to be the tracking direction (i.e., the tangential direction) on the optical disc 15 as shown in FIGS. 8B and 8C. It should be noted that even if the optical axis is refracted by a mirror or a prism in the optical system of the optical pickup, the directions are defined based on that optical axis and the mapping of the optical axis onto the optical disc.

First of all, it will be described where the outgoing light beam of the DVD/CD-compatible dual-wavelength semiconductor laser diode 111 travels in the optical pickup of this first preferred embodiment. A light beam having a wavelength associated with DVDs (or CDs), which has been emitted from the semiconductor laser diode 111, is transmitted through, and diffracted and split into a main beam and sub-beams by, the grating element 112. Next, those split light beams are reflected from a beam splitter 102 to have their optical path diverted, transmitted through the polarization beam splitter 103, and then condensed by the collimator lens 105 and the objective lens 107 onto an information storage layer of the optical disc 108, thereby forming three light beam spots (that are a main light beam spot and two sub-light beams) on the information storage layer. On the way back, the light reflected from the optical disc 108 is transformed by the objective lens 107 and the collimator lens 105 into a converged light beam. Thereafter, the converged light beam is transmitted through the beam splitters 103 and 102, subjected to astigmatism processing by a detector lens 122 and then incident on, and detected as a signal by, the photosensor 101. In this example, the objective lens 107 is supposed to be arranged on a line that passes the center axis of the optical disc and that is defined parallel to the direction in which the optical pickup 30 is moved.

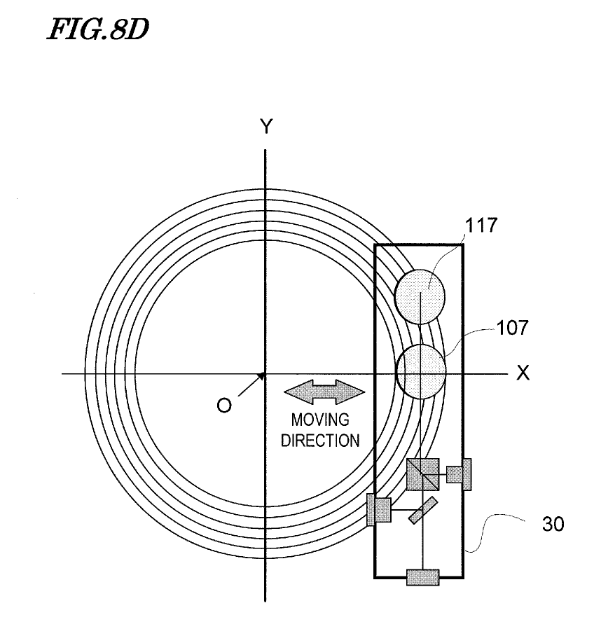

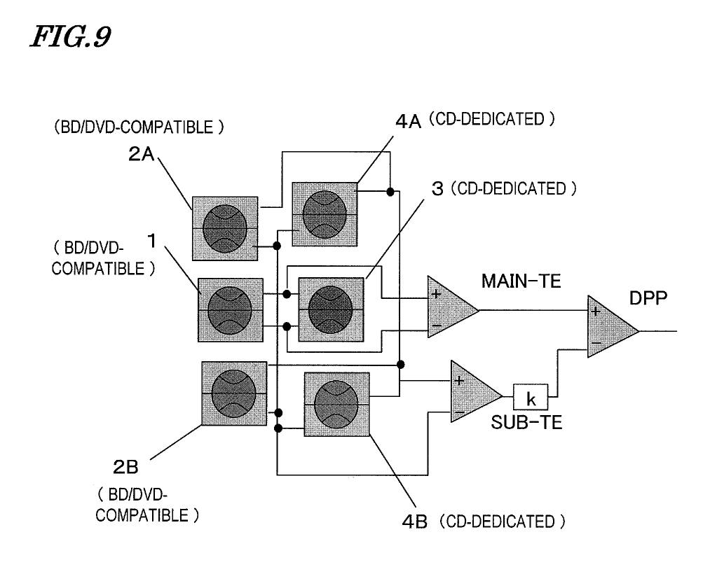

FIG. 9 illustrates a group of photodetectors of the photosensor 101. Specifically, the photosensor 101 includes a photodetector 1 that receives the main beam of the light to irradiate DVDs, photodetectors 2A and 2B that detect the two sub-beams of the light to irradiate DVDs, a photodetector 3 that receives the main beam of the light to irradiate CDs, and photodetectors 4A and 4B that detect the two sub-beams of the light to irradiate CDs. The group of DVD-compatible photodetectors and the group of CD-compatible photodetectors are arranged at two different positions because the light beam to irradiate DVDs and the light beam to irradiate CDs have been emitted from two different points in the dual-wavelength laser light source and because even after having been diffracted by the same grating element, those light beams will have mutually different angles of diffraction due to the difference in their wavelength.

Each of these photodetectors 1, 2A, 2B, 3, 4A and 4B has been further split into two photodiodes. And a tracking error signal is generated based on the difference in the intensity of the light detected between those two photodiodes.

As already described in the background section, by making the calculation represented by Equation (1) on the main TE signal generated by the photodetector 1 and the sub-TE signals generated by the photodetectors 2A and 2B with respect to the light to irradiate DVDs, a DC-offset-free DPP signal can be obtained. As for the light to irradiate CDs, on the other hand, by making the calculation represented by Equation (1) on the main TE signal generated by the photodetector 3 and the sub-TE signals generated by the photodetectors 4A and 4B, a DC-offset-free DPP signal can also be obtained.

As far as the light to irradiate DVDs or the light to irradiate CDs are concerned, the objective lens 107 is arranged right on the line that passes the center of the optical disc and that is parallel to the direction in which the optical pickup 30 is moved as described above. That is why even if the optical pickup 30 is moved either inward or outward with respect to the optical disc, the DPP signal can always be obtained with good stability. This is because the optical disc groove direction as viewed from the objective lens is always constant irrespective of the radial location of the optical pickup 30. Consequently, even if a simple grating element, of which the position has been adjusted during the manufacturing process of the optical disc, is used, signals can be obtained just as intended.

Next, it will be described where the outgoing light beam of the BD-dedicated semiconductor laser diode 121 travels in the optical pickup 30 of this first preferred embodiment.

Now look at FIG. 8B again. A light beam to irradiate BDs, which has been emitted from the semiconductor laser diode 121, is transmitted through, and diffracted and split into a main beam and sub-beams by, the grating element 110 (to be described later) as shown in FIG. 8C. Next, those split light beams are reflected from the polarization beam splitter 103 to have their optical path diverted, transmitted through the DVD/CD-compatible reflective mirror 106 due to its wavelength selecting function, and then condensed by the collimator lens 105 and the objective lens 117 onto an information storage layer of the optical disc 118, thereby forming three light beam spots (that are a main light beam spot and two sub-light beams) on the information storage layer. On the way back, the light reflected from the optical disc 118 is transformed by the objective lens 117 and the collimator lens 105 into a converged light beam. Thereafter, the converged light beam is transmitted through the beam splitters 103 and 102, subjected to astigmatism processing by the detector lens 122 and then incident on, and detected as a signal by, the photosensor 101.

As shown in FIG. 8D, the objective lens 117 is not located on the line that passes the center axis of the optical disc and that is defined parallel to the direction in which the optical pickup 30 is moved, unlike the DVD/CD-compatible objective lens 107. Specifically, in the optical pickup 30, the BD-dedicated objective lens 117 may have shifted approximately 4-5 mm in the Y-axis direction from the DVD/CD-compatible objective lens 107.

Let's go back to FIG. 9. As shown in FIG. 9, the same three-beam photodetectors are used in common for both DVDs and BDs. Although the light to irradiate BDs and the light to irradiate DVDs have mutually different wavelengths, the locations on the photosensitive plane of the photosensor, where detecting light beam spot are formed, can be matched to each other by setting different pitches for the grating element 112 for DVDs and the grating element 110 for BDs.

Consequently, by making the calculation represented by Equation (1) on the main TE signal generated by the photodetector 1 and the sub-TE signals generated by the photodetectors 2A and 2B with respect to the light to irradiate BDs, a DC-offset-free DPP signal can also be obtained.

Hereinafter, the grating element 110 of this preferred embodiment will be described.

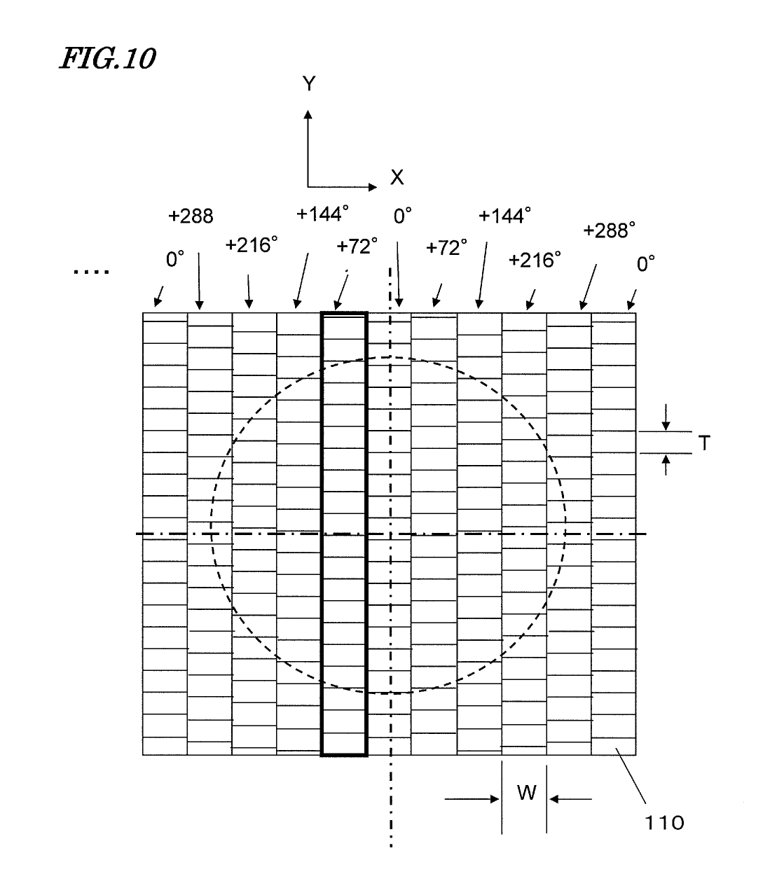

FIG. 10 is a plan view illustrating an exemplary configuration for the grating element 110 of this preferred embodiment.

The grating pattern of the grating element 110 is divided by a number of lines that are defined substantially parallel to the Y-axis (which will be referred to herein as “region division lines”) into multiple regions (which will be referred to herein as “divided regions”). In FIG. 10, one of those divided regions is surrounded by the bold rectangle so that the shape of each of those divided regions can be understood easily. Each divided region has a rectangular shape that is elongated in the Y-axis direction and also has a periodic structure for diffracting the incoming light. And those divided regions are arranged in the X-axis direction.

Although only eleven divided regions are illustrated in FIG. 10, the actual grating element 110 does not always have to have eleven divided regions. That is to say, the number of divided regions to provide for the grating element may also be greater than, or smaller than, eleven.

The grating element 110 may have any arbitrary size as long as the size is greater than the diameter of the incident light beam, and may have a size of 5 mm×5 mm and a thickness of approximately 0.3-1.0 mm. In the grating element 110 with such a size, each divided region may have a width W of 50 μm to 300 μm. In this case, the width W of each divided region is preferably defined so that the light beam spot of a single incident light beam covers at least six divided regions. Specifically, if the light beam that has been incident on the grating element 110 has a diameter of 0.5 mm, each divided region may have a width W of 50 μm to 100 μm, for example.

Among these divided regions, their periodic structure has the same constant period T but the phase of the periodic structure changes according to the position of a given divided region in the X-axis direction. Specifically, the phase of the periodic structure changes stepwise according to the position of the divided region in the X-axis direction.

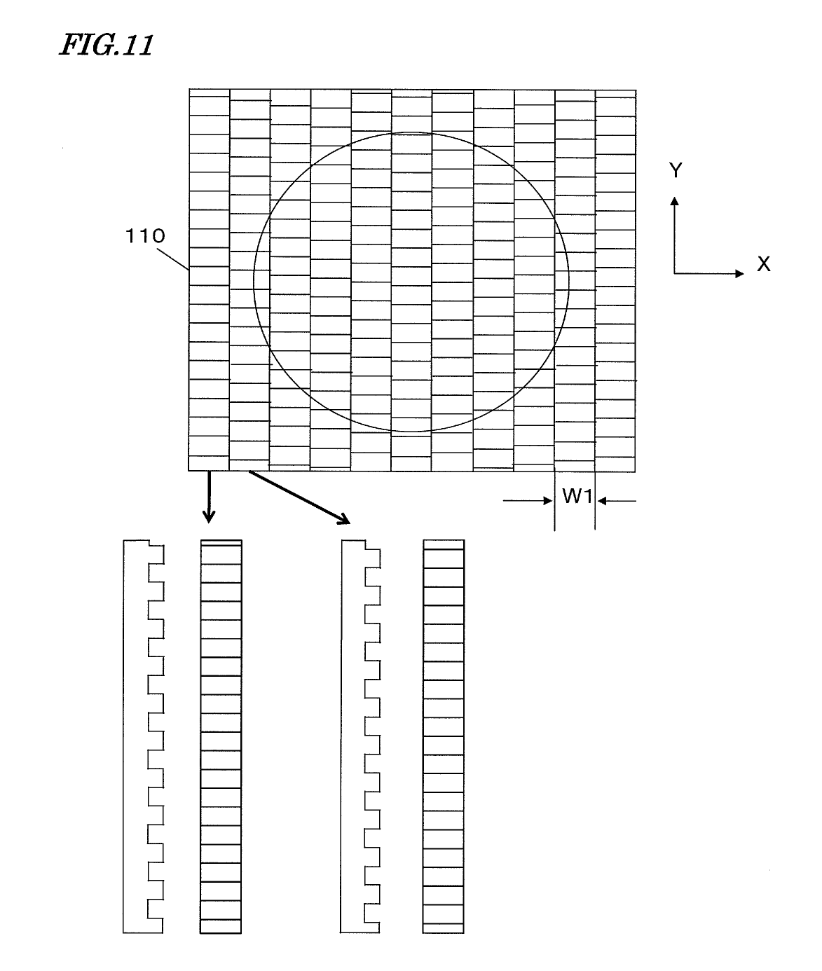

FIG. 11 illustrates the phase difference between the respective periodic structures of two adjacent divided regions. In FIG. 11, illustrated are respective cross-sectional views and front views of those two divided regions. In this example, these two periodic structures are shifted from each other by one-fifth of one period T in the Y-axis direction. Thus, this phase difference is 360°×(⅕)=72°. In this preferred embodiment, the phases of the respective periodic structures of those divided regions are symmetric to each other with respect to a centerline that is drawn to pass the center of this grating element 110. Specifically, in the example illustrated in FIG. 10, supposing the central divided region has a phase of zero degrees, the phase difference changes stepwise with a step of 72 degrees as the divided region goes farther away from the central one to the left and to the right. It should be noted that the two divided regions that are located at the two far ends of the illustrated part of the grating element 110 have a phase of zero degrees, which is equal to 360 degrees.

In the example illustrated in FIG. 10, the phase difference between each pair of adjacent divided regions is supposed to be 72 degrees over the entire range of the grating element 110. However, this is only an example. Alternatively, the phase difference may change from one position in the grating element 110 to another. And the phase difference does not have to be 72 degrees, either.

In FIG. 10, the beam cross section of the light beam that has been incident on the grating element 110 is indicated by the dashed circle. In this case, the single light beam is transmitted through, and diffracted as a whole by, multiple divided regions, thereby making three light beams. The light that has been diffracted by the grating element 110 comes to have a spherical phase wavefront in the X-axis direction and a linear phase wavefront in the Y-axis direction.

Generally speaking, if light is incident on a grating, of which the periodic structures have shifted phases, the component of the light that is transmitted through such a grating as it is (i.e., the zero-order light beam) is not affected at all. But the diffracted components (particularly ±first-order light beams in this case) will generate phase differences according to the phase shift between those periodic structures.

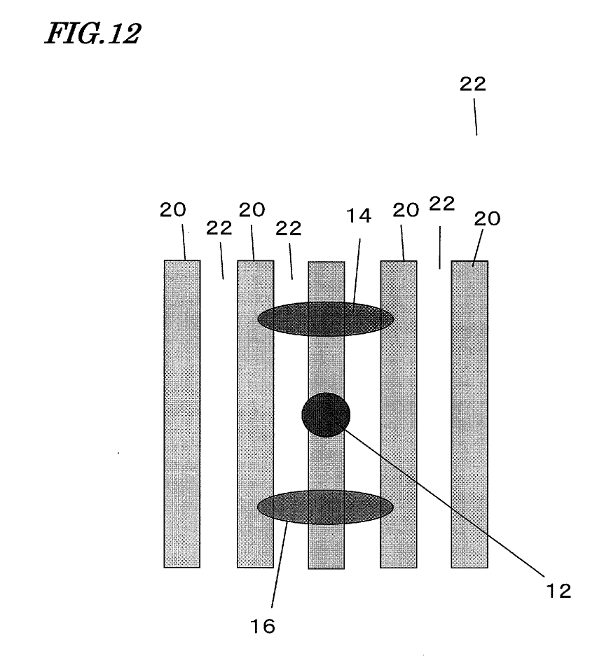

FIG. 12 illustrates light beam spots formed by sub-beams (i.e., ±first-order light beams) that have been diffracted by the grating element of this preferred embodiment on a storage layer of the optical disc.

The light that has been diffracted by the grating element 110 has a spherical phase wavefront in the X-axis direction and a linear phase wavefront in the Y-axis direction, respectively. That is why the sub-light beam spots 14 and 16 that have been condensed by the objective lens onto the storage layer of the optical disc have a shape that is broad in the X-axis direction and narrow in the Y-axis direction, i.e., an elliptical shape.

If such sub-light beam spots 14 and 16 that cover both lands 22 and grooves 20 have been formed, the AC components of the respective sub-TE signals are cancelled. In the grating element of this preferred embodiment, elongate divided regions, each having the same width W, are arranged in stripes in the X-axis direction. As a result, the light could be diffracted in the X-axis direction and could diffuse perpendicularly to the tracks on the storage layer of the optical disc. To minimize such diffraction, the divided regions may have varying widths W that increase or decrease little by little from one position to another.

In this preferred embodiment, each of the sub-light beam spots 14 and 16 has such a shape and size as to cover both grooves 20 and lands 22. In this case, it can be said that the reflected light of the sub-light beam spot 14 corresponds to a bundle of reflected light beams of normal small sub-light beam spots. That is why when crossing the tracks, some portions of the sub-light beam spot 14 that are located over grooves 20 in FIG. 12 and the other portions of the sub-light beam spot 14 that are located over lands 22 in FIG. 12 will produce reflected light beams with intensity amplitudes, of which the phases are opposite to each other. In the following description, a groove-crossing signal generated by those portions of the sub-light beam spot 14 that are located over the grooves 20 in FIG. 12 will be identified herein by TE1(14) for convenience sake. Likewise, a groove-crossing signal generated by those portions of the sub-light beam spot 14 that are located over the lands 22 in FIG. 12 will be identified herein by TE2(14).

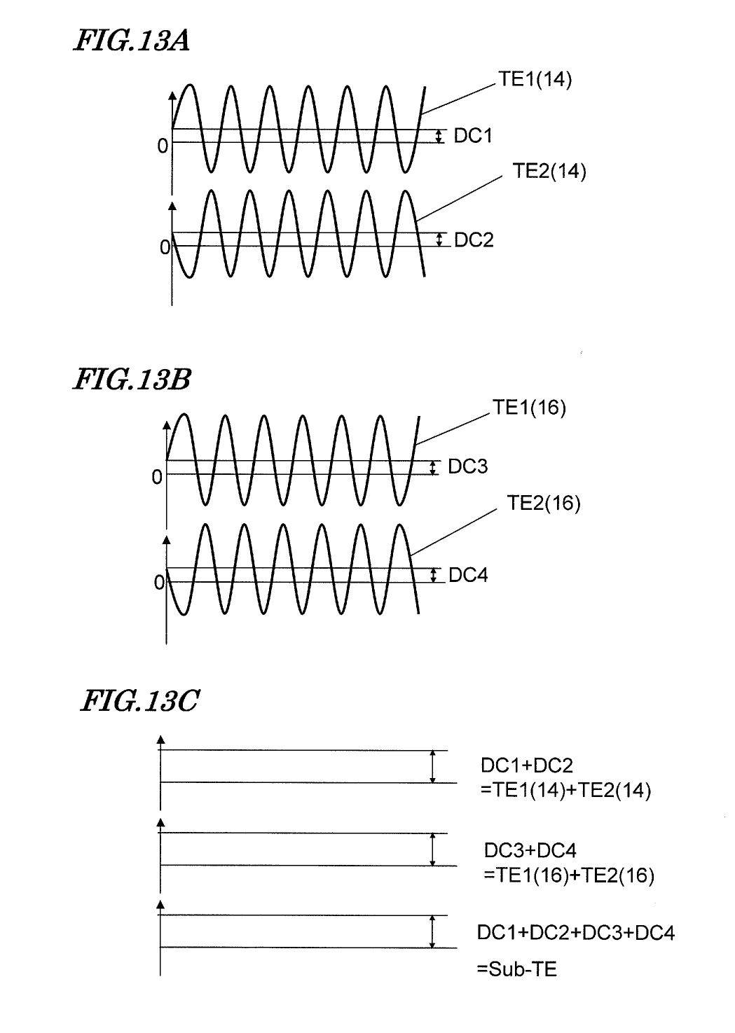

FIG. 13A shows the signal waveforms of TE1(14) and TE2(14). These signals TE1(14) and TE2(14) are not detected separately from each other but a composite signal (TE1(14)±TE2(14)) is generated by calculating the difference between the respective outputs of the two divided photodiodes of the photodetector 2A shown in FIG. 9.

The same abbreviation is applied to the other sub-light beam spot 16, too. That is to say, a groove-crossing signal generated by those portions of the sub-light beam spot 16 that are located over the grooves 20 in FIG. 12 will be identified herein by TE1(16) and a groove-crossing signal generated by those portions of the sub-light beam spot 16 that are located over the lands 22 in FIG. 12 will be identified herein by TE2(16).

FIG. 13B shows the signal waveforms of TE1(16) and TE2(16). A composite signal (TE1(16)±TE2(16)) of these signals TE1(16) and TE2(16) is generated by calculating the difference between the respective outputs of the two divided photodiodes of the photodetector 2B shown in FIG. 9.

As shown in FIG. 13A, TE1(14) and TE2(14) have AC components, of which the phases are different from each other by 180 degrees, and DC components. By controlling the light intensity distribution (and the shape and size) of the sub-light beam spot 14 on the optical disc, the respective amplitudes of the AC components of TE1(14) and TE2(14) can be equalized with each other. If the amplitudes of those AC components are equalized with each other, then their phases will be different from each other by 180 degrees. That is why by adding TE1(14) and TE2(14) together, those AC components can be cancelled. As a result, the sum of TE1(14) and TE2(14) becomes equal to DC1+DC2, where DC1 and DC2 represent the DC components of TE1(14) and TE2(14), respectively.

Likewise, TE1(16) and TE2(16) also have AC components, of which the phases are different from each other by 180 degrees, and DC components as shown in FIG. 13B. By controlling the light intensity distribution (and the shape and size) of the sub-light beam spot 16 on the optical disc, the respective amplitudes of the AC components of TE1(16) and TE2(16) can be equalized with each other as described above. Then by adding TE1(16) and TE2(16) together, those AC components can be cancelled. As a result, the sum of TE1(16) and TE2(16) becomes equal to DC3+DC4, where DC3 and DC4 represent the DC components of TE1(16) and TE2(16), respectively.

FIG. 13C shows the respective signal waveforms of TE(14)=TE1(14)−TE2(14) generated by forming the sub-light beam spot 14, TE(16)=TE1(16)+TE2(16) generated by forming the sub-light beam spot 16, and Sub-TE=TE(14)+TE(16) according to this preferred embodiment. As can be seen from FIG. 13C, each of these signal waveforms substantially has only DC components.

In the photosensor shown in FIG. 9, TE1(14)+TE2(14) is the difference between the two outputs of the photodetector 2A and TE1(16)+TE2(16) is the difference between the two outputs of the photodetector 2B. These signals are actually not generated separately but their composite signal is generated as Sub-TE. That is to say, Sub-TE=TE1(14)+TE2(14)+TE1 (16)+TE2 (16)==DC1+DC2+DC3+DC4 is satisfied.

The signal represented by DC1+DC2+DC3+DC4 is a signal, of which the AC components have been cancelled, but does correspond to a DC offset that has been caused due a lens shift, for example.

According to the three-beam tracking and detecting method of this preferred embodiment, by making a calculation on the main TE signal with AC components and a DC offset and on the sub-TE signal with a DC offset but with no AC components, a TE signal with no DC offset can be obtained. The sub-TE has no AC components. That is why even if the groove direction as viewed from the objective lens (i.e., the tangential direction that is defined at each location with respect to the concentric circles) changes according to the radial location of the optical pickup, no phase shift will be caused between the groove-crossing waveforms of the main and sub-TE signals, and a variation in the amplitude of the DPP signal can be minimized.

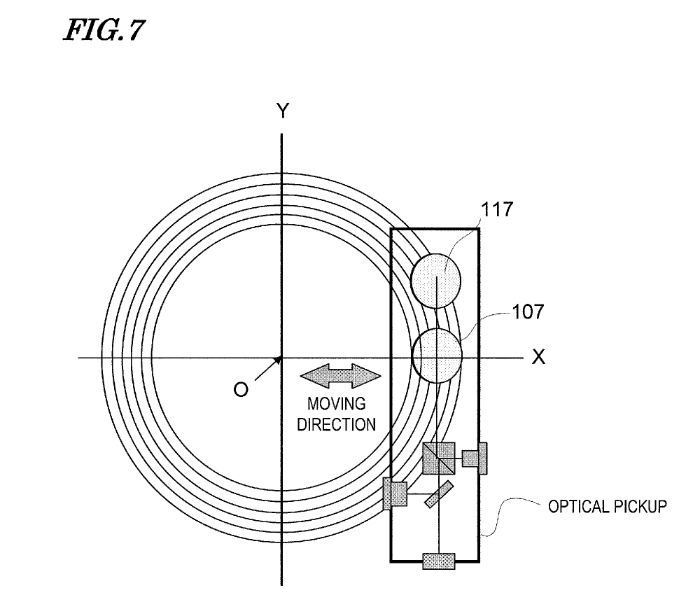

Optionally, the grating element 110 of this preferred embodiment is also applicable to an optical pickup that has only one objective lens to be moved along the line that passes the center of the optical disc and that is parallel to the X-axis (see FIG. 7). In that case, even if the optical pickup is moved, the groove direction as viewed from the objective lens will never change. However, according to this preferred embodiment, not just can that problem be avoided but also can the need for adjusting the rotation of the grating element be eliminated as well. If the rotation of the grating element does not have to be adjusted anymore, the process of assembling the optical pickup will require much less precision. To achieve this effect, the grating element 110 of this preferred embodiment may be applied to a DVD/CD-compatible objective lens in an optical pickup with a two-lens structure. The same can be said about any of the preferred embodiments of the present invention to be described below.

### Embodiment 2

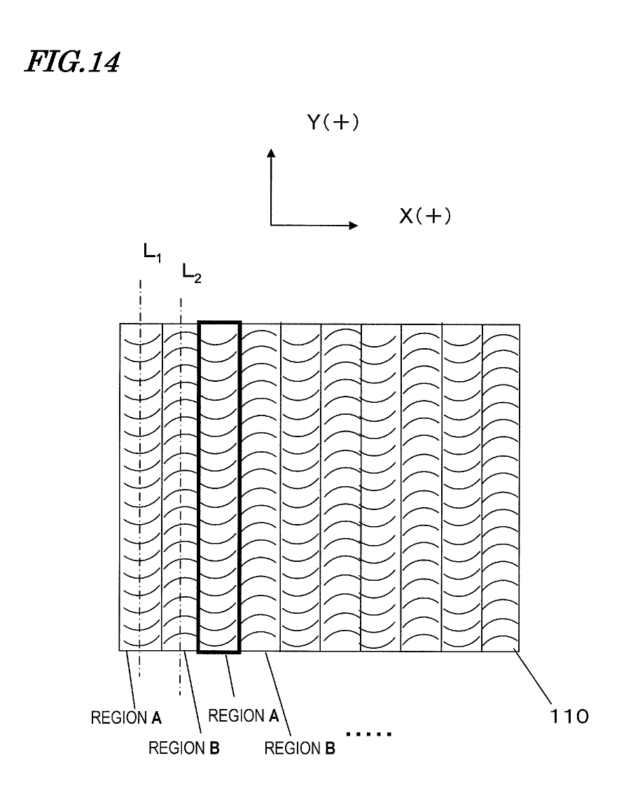

Hereinafter, an optical pickup as a second preferred embodiment of the present invention will be described. FIG. 14 is a plan view illustrating a grating element 110 according to this second preferred embodiment of the present invention.

The grating pattern of the grating element 110 is divided by a number of lines that are defined substantially parallel to the Y-axis (which will be referred to herein as “region division lines”) into multiple regions (which will be referred to herein as “divided regions”). In FIG. 14, one of those divided regions is surrounded by the bold rectangle so that the shape of each of those divided regions can be understood easily. Each divided region has a rectangular shape that is elongated in the Y-axis direction and also has a periodic structure for diffracting the incoming light. And those divided regions are arranged in the X-axis direction.

According to this preferred embodiment, two groups of divided regions A and B, of which the periodic structures have mutually different planar patterns, are arranged alternately. Each of these divided regions has a concentric periodic structure. Specifically, each divided region A has a structure in which portions of concentric circles, of which the centers are located on the Y+ side of its centerline L1, are arranged periodically to form a grating pattern. On the other hand, each divided region B has a structure in which portions of concentric circles, of which the centers are located on the Y− side of its centerline L2, are arranged periodically to form a grating pattern.

The grating element of the first preferred embodiment described above is designed to shift the phase wavefront of the diffracted light stepwise on a divided region basis. On the other hand, according to this second preferred embodiment, the respective divided regions curve the phase wavefront of the diffracted light.

FIG. 15 illustrates light beam spots 12, 14 and 16 that have been formed by the grating element 110 of the second preferred embodiment of the present invention on the storage layer of the optical disc.

Generally speaking, if light is incident on a diffraction grating with a concentric pattern, the diffracted light will be condensed onto the center axis of the concentric circles due to the lens function of the diffraction grating with such a concentric pattern. As a result, an elliptical light beam spot, which is elongate in the X-axis direction, is formed on a storage layer of the optical disc. That is to say, a sub-light beam spot, which covers both lands and grooves, is formed, and therefore, the AC components of the resultant sub-TE signal are cancelled.

On top of that, by alternately arranging one group of regions, of which the center of the concentric circles is located on one side, and another group of regions, of which the center of the concentric circles is located on the opposite side, ±first-order diffracted light beams to be produced by such a grating element are affected symmetrically in the Y-axis direction. As a result, two very similar sub-light beam spots are formed by the ±first-order light beams.

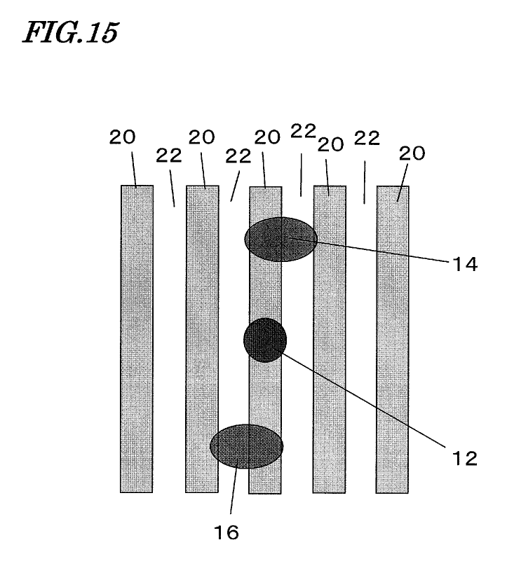

In this preferred embodiment, each of the sub-light beam spots 14 and 16 also has such a shape and size as to cover both grooves 20 and lands 22 as shown in FIG. 15. That is why when crossing the tracks, some portions of the sub-light beam spot 14 that are located over grooves 20 in FIG. 15 and the other portions of the sub-light beam spot 14 that are located over lands 22 in FIG. 15 will produce reflected light beams with intensity amplitudes, of which the phases are opposite to each other. In the following description, a groove-crossing signal generated by those portions of the sub-light beam spot 14 that are located over the grooves 20 in FIG. 15 will be identified herein by TE1(14). Likewise, a groove-crossing signal generated by those portions of the sub-light beam spot 14 that are located over the lands 22 in FIG. 15 will be identified herein by TE2(14). FIG. 16A shows the signal waveforms of TE1(14) and TE2(14).

The same abbreviation is applied to the other sub-light beam spot 16, too. That is to say, a groove-crossing signal generated by those portions of the sub-light beam spot 16 that are located over the grooves 20 in FIG. 15 will be identified herein by TE1(16) and a groove-crossing signal generated by those portions of the sub-light beam spot 16 that are located over the lands 22 in FIG. 15 will be identified herein by TE2(16). FIG. 16B shows the signal waveforms of TE1(16) and TE2(16).

As already described for the first preferred embodiment, by controlling the light intensity distribution (and the shape and size) of the sub-light beam spot 14 on the optical disc, the respective amplitudes of the AC components of TE1(14) and TE2(14) can be equalized with each other. If the amplitudes of those AC components are equalized with each other, then their phases will be different from each other by 180 degrees. That is why by adding TE1(14) and TE2(14) together, those AC components can be cancelled. As a result, the sum of TE1(14) and TE2(14) becomes equal to DC1+DC2, where DC1 and DC2 represent the DC components of TE1(14) and TE2(14), respectively.

Likewise, TE1(16) and TE2(16) also have AC components, of which the phases are different from each other by 180 degrees, and DC components as shown in FIG. 16B. Thus, by controlling the light intensity distribution (and the shape and size) of the sub-light beam spot 16 on the optical disc, the respective amplitudes of the AC components of TE1(16) and TE2(16) can be equalized with each other as described above. Then by adding TE1(16) and TE2(16) together, those AC components can be cancelled.

FIG. 16C shows the respective signal waveforms of TE(14)==TE1(14)+TE2(14) generated by forming the sub-light beam spot 14, TE(16)=TE1(16)+TE2(16) generated by forming the sub-light beam spot 16, and Sub-TE=TE(14)+TE(16) according to this preferred embodiment. As can be seen from FIG. 16C, each of these signal waveforms substantially has only DC components.

Consequently, the effects achieved by the first preferred embodiment of the present invention described above can also be achieved by this preferred embodiment.

### Embodiment 3

Hereinafter, a third preferred embodiment of the present invention will be described. The optical disc drive of this preferred embodiment has quite the same configuration as its counterpart of the first preferred embodiment that has already been described with reference to FIG. 8A. The optical pickup of this preferred embodiment also has the same configuration as its counterpart of the first preferred embodiment described above except the grating element 110.

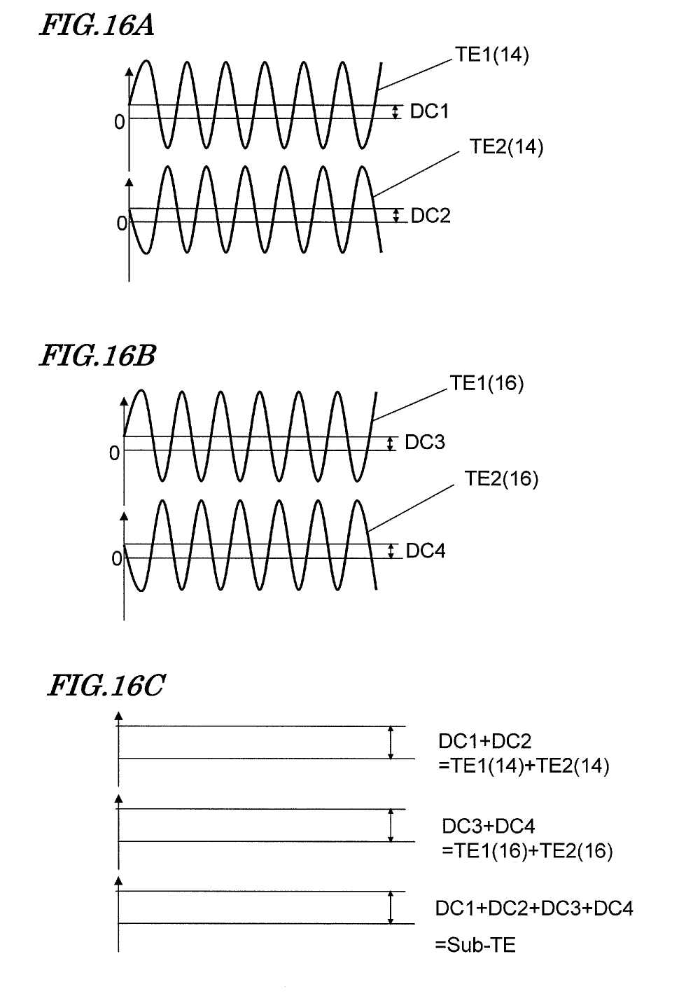

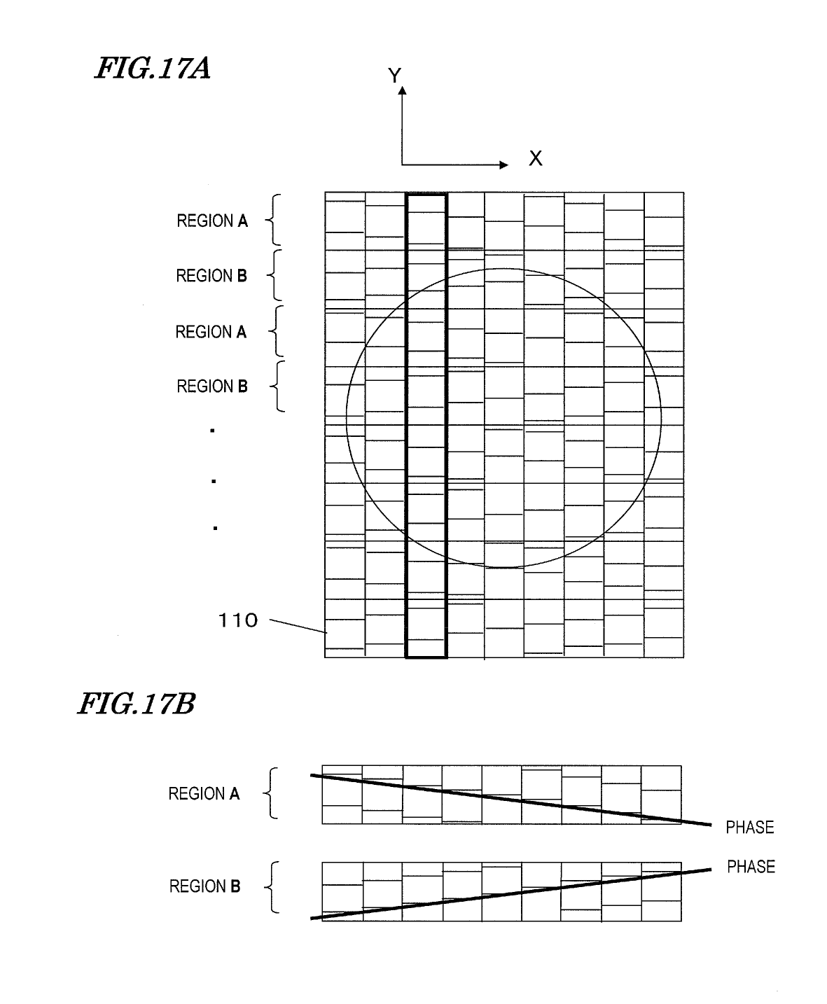

FIG. 17A is a plan view illustrating the diffraction area of a grating element 110 according to this third preferred embodiment of the present invention.

The grating pattern of the grating element 110 of this preferred embodiment is basically the same as that of the grating element 110 of the first preferred embodiment described above. That is to say, the grating pattern of this grating element 110 is also divided by a number of lines that are defined substantially parallel to the Y-axis (which will be referred to herein as “region division lines”) into multiple regions (which will be referred to herein as “divided regions”). In FIG. 17A, one of those divided regions is surrounded by the bold rectangle so that the shape of each of those divided regions can be understood easily. Each divided region has a rectangular shape that is elongated in the Y-axis direction and also has a periodic structure for diffracting the incoming light. And those divided regions are arranged in the X-axis direction.

The grating pattern of the grating element 110 of this preferred embodiment is further divided by a number of lines that are defined substantially parallel to the X-axis (which will also be referred to herein as “region division lines”). As a result, first and second groups of regions A and B are alternately arranged as the divided regions in the Y-axis direction.

The first group of regions A are arranged in the X-axis direction and the phase of their periodic structure changes stepwise in the X-axis direction. In the same way, the second group of regions B are also arranged in the X-axis direction and the phase of their periodic structure also changes stepwise in the X-axis direction. FIG. 17B illustrates one row of the first group of regions A arranged in the X-axis direction and one row of the second group of regions B arranged in the X-axis direction. As can be seen from FIG. 17B, the phase shift directions of the first and second groups of regions A and B are opposite to each other.

Generally speaking, if light is incident on such a grating, in which there are two kinds of periodic structures with mutually shifted phases, the component of the light that is transmitted through the grating as it is (i.e., the zero-order light beam) is not affected at all. On the other hand, the components of the light diffracted by the grating (particularly ±first-order light beams in this case) will have a phase difference due to the phase shift between the periodic structures. Consequently, the ±first-order light beams that have been diffracted by the grating with the configuration shown in FIG. 17A are split into a light beam with a phase distribution that gradually decreases rightward for the first group of regions A and a light beam with a phase distribution that gradually increases rightward for the second group of regions B.

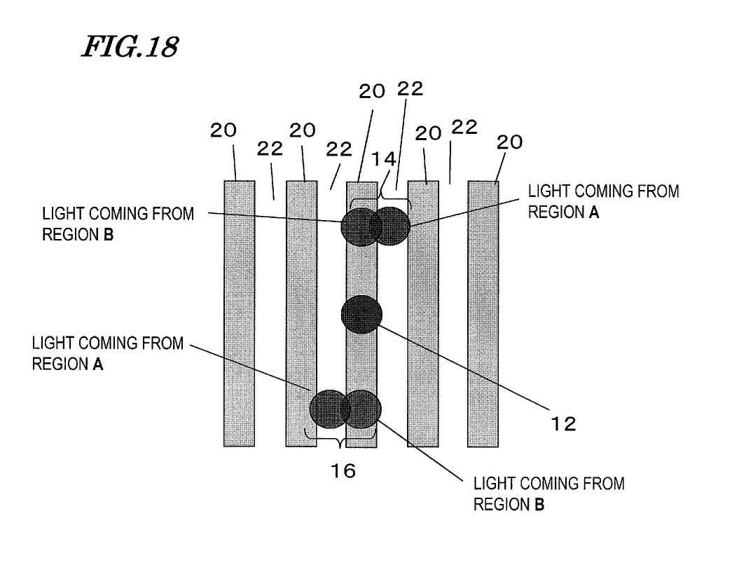

FIG. 18 illustrates the light beam spots that have been formed by the grating element 110 of this preferred embodiment on a storage layer of the optical disc. As in the conventional arrangement, sub-light beam spots 14 and 16 of the ±first-order light beams are respectively formed over and under the main light beam spot 12. In this case, however, the spot of a light beam that has been transmitted through one region A in the first group of the grating element 110 may be formed on a land 22, while the spot of a light beam that has been transmitted through one region B in the second group of the grating element 110 may be formed on a groove 20. As for the +first-order light beam, the spots of the light beams that have been transmitted through the regions A and B of the first and second groups are too close to each other to avoid interference between them, thus forming substantially one sub-light beam spot 14 eventually. Likewise, as for the −first-order light beam, the spots of the light beams that have been transmitted through the regions A and B of the first and second groups are too close to each other to avoid interference between them, thus forming substantially one sub-light beam spot 16 eventually.

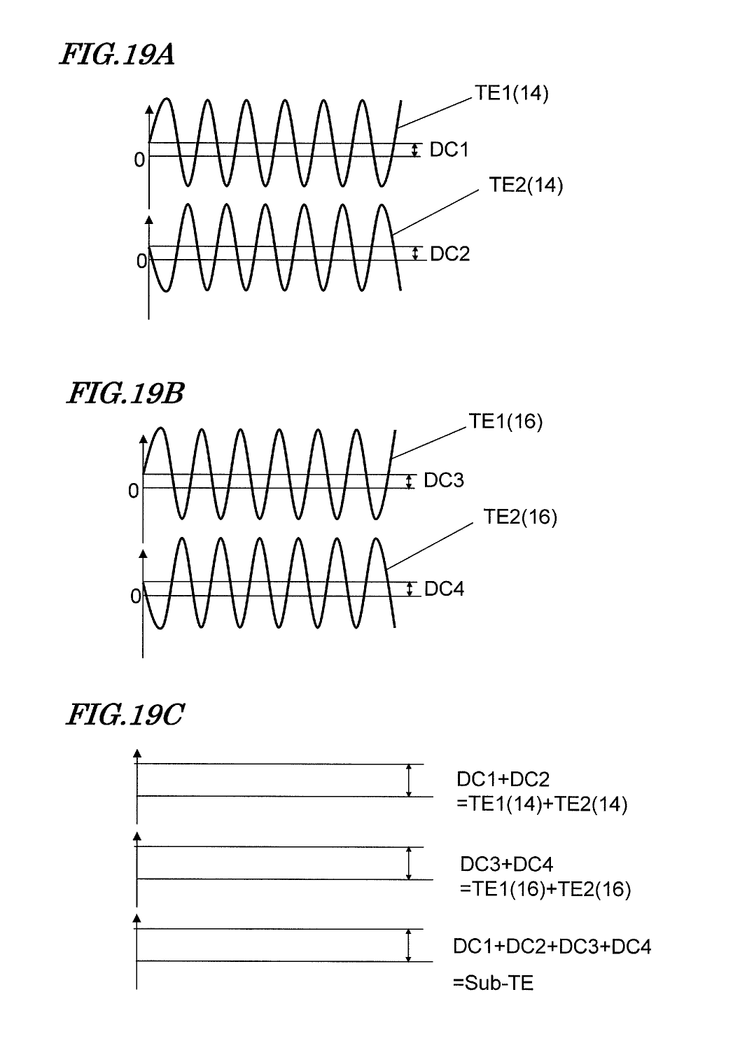

Now, let us discuss what groove-crossing signal will be generated when a reflected light beam corresponding to the sub-light beam spot 14 of the +first-order light beam is detected by the photodetector shown in FIG. 9. That groove-crossing signal will be obtained by combining a groove-crossing signal TE1 generated by the light beam that has come from the region A in the first group and a groove-crossing signal TE2 generated by the light beam that has come from the region B in the second group with each other. FIG. 19 illustrates the respective waveforms of the groove-crossing signals TE1 and TE2 and their sum signal. Since the spots of the light beams that have been transmitted through the regions A and B in the first and second groups are located on the land and the groove 20, respectively, these groove-crossing signals TE1 and TE2 have mutually opposite phases. As a result, in the signals obtained by converting these groove-crossing signals TE1 and TE2, the AC components have been cancelled.

In this preferred embodiment, each of the sub-light beam spots 14 and 16 also has such a shape and size as to cover both grooves 20 and lands 22 overall as shown in FIG. 18. That is why when crossing the tracks, some portions of the sub-light beam spot 14 that are located over grooves 20 in FIG. 18 (most of which has been formed by a light beam that has come from a region B in the second group) and the other portions of the sub-light beam spot 14 that are located over lands 22 in FIG. 18 (most of which has been formed by a light beam that has come from a region A in the first group) will produce reflected light beams with intensity amplitudes, of which the phases are opposite to each other. In the following description, a groove-crossing signal generated by those portions of the sub-light beam spot 14 that are located over the grooves 20 in FIG. 18 (most of which has been formed by a light beam that has come from a region B in the second group) will be identified herein by TE1(14). Likewise, a groove-crossing signal generated by those portions of the sub-light beam spot 14 that are located over the lands 22 in FIG. 18 (most of which has been formed by a light beam that has come from a region A in the first group) will be identified herein by TE2(14). FIG. 19A shows the signal waveforms of TE1(14) and TE2(14).

In this case, in each of the sub-light beam spots 14 and 16, the light beam that has come from the region A irradiates both the groove 20 and the land 22, so does the light beam that has come from the region B.

According to this preferred embodiment, if the interval between the sub-light beam spots formed by the light beams that have come from the regions A and B of the grating element (i.e., the relative difference between the phase gradients of the regions A and B) is determined appropriately, their phases will be exactly opposite to each other. And a groove-crossing signal associated with the +first-order light beam, which is obtained by combining their groove-crossing signals TE1(14) and TE2(14) together, becomes a signal, of which the AC components have been cancelled. But its DC component that has been caused due to a lens shift, for example, stays intact. In this case, as long as the interval between the sub-light beam spots formed by the light beams that have come from the regions A and B satisfies such a cancelling relation, those sub-light beam spots may be located anywhere on the track grooves.

In the same way, a groove-crossing signal generated by those portions of the sub-light beam spot 16 that are located over the grooves 20 in FIG. 18 (most of which has been formed by the light beam that has come from the region B) will be identified herein by TE1(16). Likewise, a groove-crossing signal generated by those portions of the sub-light beam spot 16 that are located over the lands 22 in FIG. 18 (most of which has been formed by the light beam that has come from the region A) will be identified herein by TE2(16). FIG. 19B shows the signal waveforms of TE1(16) and TE2(16).

FIG. 19C shows the respective signal waveforms of TE(14)=TE1(14)+TE2(14) generated by forming the sub-light beam spot 14, TE(16)=TE1(16)+TE2(16) generated by forming the sub-light beam spot 16, and Sub-TE=TE(14)+TE(16) according to this preferred embodiment. As can be seen from FIG. 19C, each of these signal waveforms substantially has only DC components.

According to the three-beam tracking and detecting method of this preferred embodiment, a sub-TE with no AC component but with a DC offset is obtained. That is why by subtracting a DC offset from the main TE with AC components and the DC offset, a DC-offset-free TE signal can be obtained. In that case, even if the groove direction as viewed from the objective lens changes continuously as the radial location of the optical pickup changes with respect to the optical disc, it is still possible to prevent the amplitude of the DPP signal from varying due to a phase shift of the groove-crossing signal because the sub-TE has no AC components.

According to this preferred embodiment, as two light beam spots are combined together, part of the resultant sub-light beam spot expands on either side perpendicularly to the tracking direction. Nevertheless, that expanded part of the sub-light beam spot covers no more than one groove 20 and one land 22. If recorded and unrecorded areas with mutually different reflectances are present on the same optical disc, the main light beam spot and the sub-light beam spot will cause a variation substantially at the same time when crossing the boundary between the recorded and unrecorded areas. Consequently, the DPP signal, obtained by making a calculation on the main TE and the sub-TE, hardly varies, which is another advantage of the present invention.

The optical pickup, optical information processor and signal detecting method of the present invention are used to read and write information from/on an information storage medium and can be used effectively for reading and writing audio data, video data, PC data and other kinds of data. The present invention is also applicable for use to save or archive computer data and programs or map data for car navigation systems and for many other purposes.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2010-250521 filed Nov. 9, 2010 and No. 2011-089416 filed Apr. 13, 2011, the entire contents of which are hereby incorporated by reference.

What is claimed is:

1. An optical pickup comprising:
a light source for emitting light;
a grating element for splitting the light emitted from the light source into multiple light beams including a zero-order diffracted light beam, a −first-order diffracted light beam, and a +first-order diffracted light beam;
an objective lens for condensing the zero-order diffracted light beam and the ±first-order diffracted light beams, which have come from the grating element, onto an optical disc; and
a photosensor that has multiple photodetectors for receiving respectively the three diffracted light beams that have been reflected from the optical disc,
wherein the grating element is designed so that when measured perpendicularly to tracks on the optical disc, sub-light beam spots that are formed on the optical disc by the ±first-order diffracted light beams are larger than a main light beam spot that is formed on the optical disc by the zero-order diffracted light beam.

2. The optical pickup of claim 1, wherein each said sub-light beam spot is wide enough to cover, or at least overlap with, both lands and grooves of the disc.

3. The optical pickup of claim 1, wherein the grating element is comprised of a number of divided regions that are arranged in a first direction, and
wherein each said divided region has a periodic structure for diffracting incoming light, the period of the periodic structure is constant no matter where the divided region is located in the first direction, but the phase of the periodic structure changes stepwise according to the location of the divided region in the first direction.

4. The optical pickup of claim 3, wherein those divided regions are arranged in stripes so as to run in a second direction that is defined perpendicularly to the first direction.

5. The optical pickup of claim 4, wherein the phase of the periodic structure does not change within each said striped divided region.

6. The optical pickup of claim 5, wherein the periodic structures of the divided regions are symmetric with respect to a line that passes the center of the grating element and that is defined parallel to the second direction.

7. The optical pickup of claim 5, wherein the periodic structure of each said divided region forms respective parts of concentric curves within that divided region.

8. The optical pickup of claim 4, wherein the divided regions have non-uniform widths.

9. The optical pickup of claim 4, wherein each said divided region has first and second groups of regions that are arranged alternately in the second direction, and
wherein the first group of regions that are included in the multiple divided regions are arranged in the first direction and the phases of their periodic structures change stepwise in the first direction, and
wherein the second group of regions that are included in the multiple divided regions are also arranged in the first direction and the phases of their periodic structures change stepwise in the first direction, and
wherein the phase shift of the periodic structures of the first group of regions has an opposite polarity to that of the periodic structures of the second group of regions.

10. The optical pickup of claim 9, wherein the divided regions have non-uniform widths.

11. The optical pickup of claim 1, further comprising:
a second light source for emitting light;
a second grating element for splitting the light emitted from the second light source into multiple light beams including a zero-order diffracted light beam, a −first-order diffracted light beam, and a +first-order diffracted light beam;
a second objective lens for condensing the zero-order diffracted light beam and the ±first-order diffracted light beams, which have come from the second grating element, onto an optical disc; and
a second photosensor that has multiple photodetectors for receiving respectively the three diffracted light beams that have been reflected from the optical disc.

12. An optical disc drive comprising:
an optical pickup;
a motor for rotating an optical disc; and
a control section for performing a tracking control in response to a tracking error signal that has been generated by the optical pickup,
wherein the optical pickup comprises:
a light source for emitting light;
a grating element for splitting the light emitted from the light source into multiple light beams including a zero-order diffracted light beam, a −first-order diffracted light beam, and a +first-order diffracted light beam;
an objective lens for condensing the zero-order diffracted light beam and the ±first-order diffracted light beams, which have come from the grating element, onto an optical disc; and
a photosensor that has multiple photodetectors for receiving respectively the three diffracted light beams that have been reflected from the optical disc,
wherein the grating element is designed so that when measured perpendicularly to tracks on the optical disc, sub-light beam spots that are formed on the optical disc by the ±first-order diffracted light beams are larger than a main light beam spot that is formed on the optical disc by the zero-order diffracted light beam.

13. The optical disc drive of claim 12, wherein the control section cancels the DC components of a main tracking error signal that has been generated based on the main light beam spot with those of sub-tracking error signals that have been generated based on the sub-light beam spots.

14. The optical disc drive of claim 12, wherein if a line is defined so as to pass the center of the optical disc and to be parallel to the direction in which the optical pickup is moved, the position of the objective lens is shifted perpendicularly to that line.

15. The optical disc drive of claim 12, wherein the optical pickup further comprises another objective lens that is located on a line that passes the center of the optical disc and is parallel to the direction in which the optical pickup is moved.
